(19) United States
(12) Patent Application Publication
(10) Pub. No.: US 2011/0170999 A1
(43) Pub. Date: Jul. 14, 2011

(54) FORKLIFT TINE ATTACHMENT

(75) Inventor: Bruce Hailston, Midland, MI (US)

(73) Assignee: MAGLINE INCORPORATED, Standish, MI (US)

(21) Appl. No.: 12/986,296

(22) Filed: Jan. 7, 2011

Related U.S. Application Data
(60) Provisional application No. 61/293,910, filed on Jan. 11, 2010.

(51) Int. Cl. B66F 9/12

(52) U.S. Cl. 414/607

(57) ABSTRACT

A forklift tine attachment comprising a lower portion which slides over the tines of the forklift and an upper portion which comprises two generally horizontal load-carrying surfaces which extend laterally beyond the width of the tine to provide greater stability, such that one load can be carried on each load-carrying surface. The lower sleeve is attached securely to the forklift by fastening a bolt through the sleeve behind the vertically-oriented portion of the tine, and the two sleeves may also be connected with a telescopically adjustable connector to provide additional stability of the load-carrying surfaces. The attachment may also include features to facilitate proper positioning and stable transport such as lead-in edges, pallet backstops, raised lateral edges on the load-carrying surface or pallet positioners.

### CROSS REFERENCE TO RELATED APPLICATIONS

Applicant claims priority to United States Provisional Patent Application Ser. No. 61/293910 entitled FORKLIFT TINE ATTACHMENT, filed Jan. 11, 2010.

### FIELD OF THE INVENTION

The present invention relates generally to material handling, and more particularly to attachments for the standard tines of a forklift for supporting and securely transporting loads.

### SUMMARY OF THE INVENTION

The invention relates to a forklift tine attachment, designed to slide over existing standard forklift tines, and provide a load-carrying surface above each of the standard tines, extending laterally beyond the width of the tines to better support and transport loads, particularly loads other than, or in addition to, standard wooden pallets. The lateral extension of the load-carrying surface allows each tine to carry its own narrowed pallet in a stable and secure manner, without the use of the other tine, such that two narrow pallets can be carried simultaneously without stacking the pallets. The forklift tine attachment may also be customized to a particular pallet or other load being transported to facilitate loading and further provide stability and support for transporting the particular load, for example, by adding positioning or retention features that coordinate with the particular pallet or load being transported.

### BRIEF DESCRIPTION OF THE DRAWINGS

FIG. 1 is a top perspective view of the forklift tine attachment.

FIG. 2 is a top perspective view of the forklift tine attachment when installed on the tines of a forklift.

FIG. 3 is a front view of the forklift tine attachment with two empty pallets loaded on the forklift tine attachment.

FIG. 4 is a front view of the forklift tine attachment with two loaded pallets on the forklift tine attachment.

FIG. 5 is a bottom view of the forklift tine attachment.

FIG. 6 is a side view of the forklift tine attachment.

FIG. 7 is a top view of the forklift tine attachment, illustrating the optional positioner feature.

### DESCRIPTION OF THE PREFERRED EMBODIMENTS

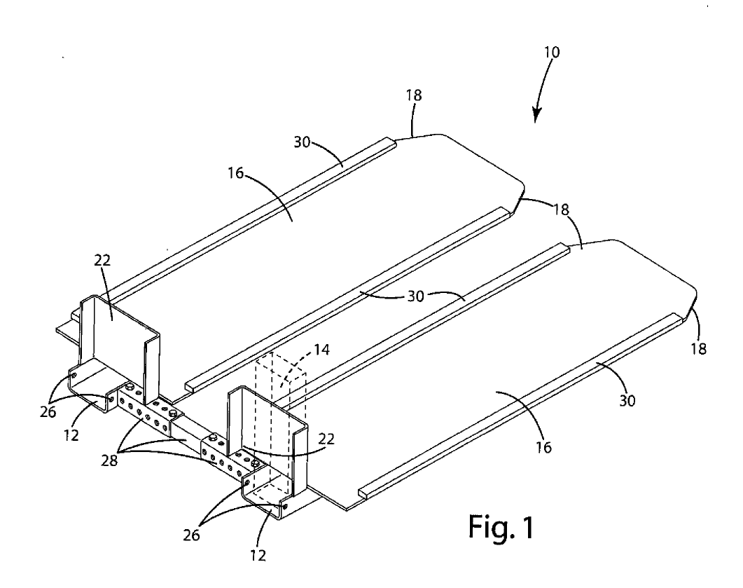

In one embodiment of the forklift tine attachment 10, as shown in FIGS. 1, 2, and 5 there are two sleeves 12, wherein each sleeve 12 has a generally rectangular cross section which is sized to allow the sleeve 12 to slide over the horizontal portion of the forklift tine 14. At least the top section of each sleeve 12 is longer than the horizontal portion of the tine 14, such that each sleeve 12 extends at least slightly beyond the forward end of the tine 14 over which it is placed when the sleeve 12 is fully inserted over the tine 14. The top side of each sleeve 12 functions as the load-carrying surface 16, and is a generally horizontal surface which extends laterally beyond the width of the tine 14 over which it is placed.

In the preferred embodiment as shown in FIGS. 1, 2 and 5 each load-carrying surface 16 of the tine attachment 10 is generally rectangular in shape, with angled lead-in edges 18 on the front two corners of the load-carrying surface 16 (farthest from the operator). The angled lead-in edges 18 on the forward end of the load-carrying surface 16 provide more leeway in the operator's positioning of the tine attachment 10 next to a pallet 20 to facilitate the operator's ability to pick up the pallet 20. The rear edge of each load-carrying surface 16 is defined by a pallet back stop 22 to assist in positioning of the pallet 20 on the load-carrying surface 16 and prevent the pallet 20 and any of its features from interfering with the tine attachment 10 and its interface with the forklift tines 14.

As best illustrated in FIG. 1, the bottom and sides of the sleeve 12 extend rearwardly behind the pallet backstop 22 and the tines 14 such that a bolt 24 can be threaded through coaxially aligned openings 26 in the sides of each sleeve 12 to fasten behind the vertical portion of the forklift tine 14 to secure the tine attachment 10 to the tine 14. The medial side of each sleeve 12 is connected to the medial side of the other sleeve 12 with an adjustable, telescoping tube 28 which allows the sleeves 12 to be spaced at the desired distance to fit over the forklift tines 14 and which also provides additional torsional rigidity and additional reinforcement which allows the load-carrying surface 16 to remain in a generally horizontal position.

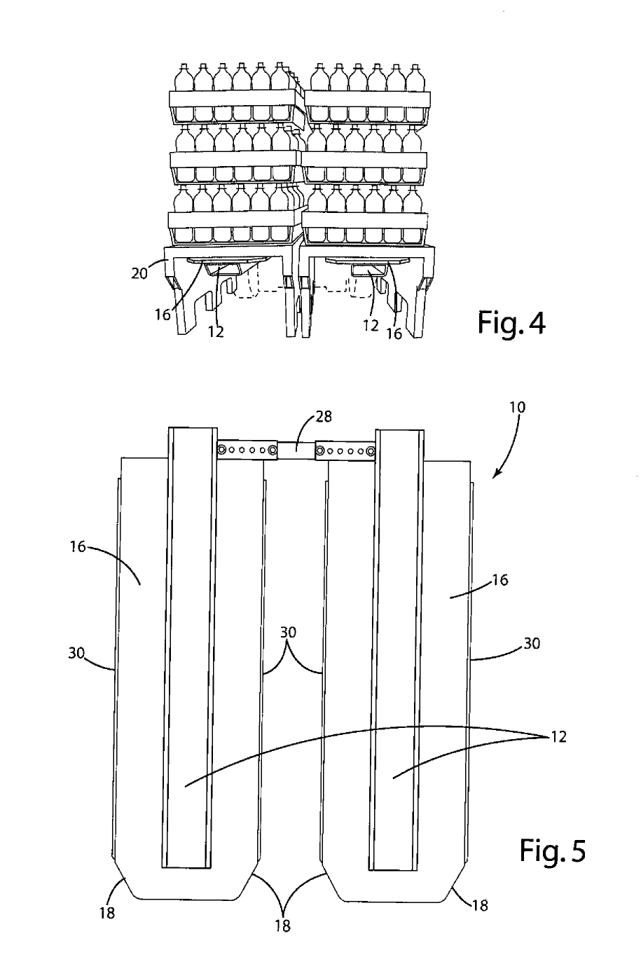

As shown in FIG. 3, the forklift tine attachment 10 described herein may be adapted for use with particular pallets 20, such as those described in U.S. application Ser. No. 12/578,834, filed Oct. 14, 2009, which claims priority from U.S. Provisional Application Ser. No. 61/106,975 (which application is herein incorporated by reference). Each pallet 20 according to that application, as further described therein, has increased ground clearance under the pallet 20 where the forklift tine 14 can be inserted and a narrower pallet body than a traditional pallet 20, such that each load-carrying surface 16 of the tine attachment 10 can be inserted under the load carrying surface of a different pallet 20 to raise two pallets 20 at a time, as shown in FIG. 4. The laterally extended load-carrying surface 16 provides additional stability to the pallet 20 while the pallet 20 is carried on an individual forklift tine 14.

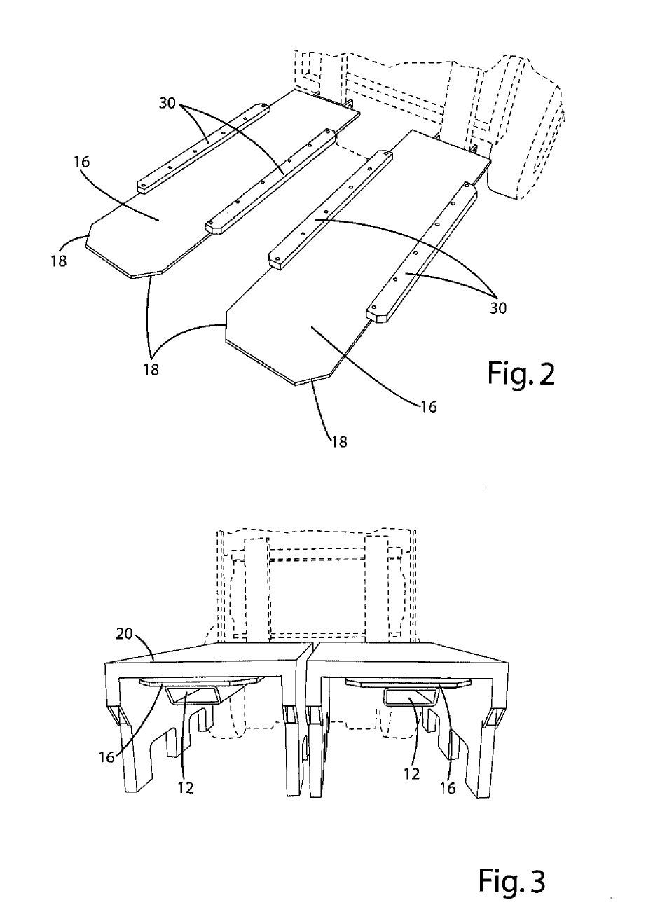

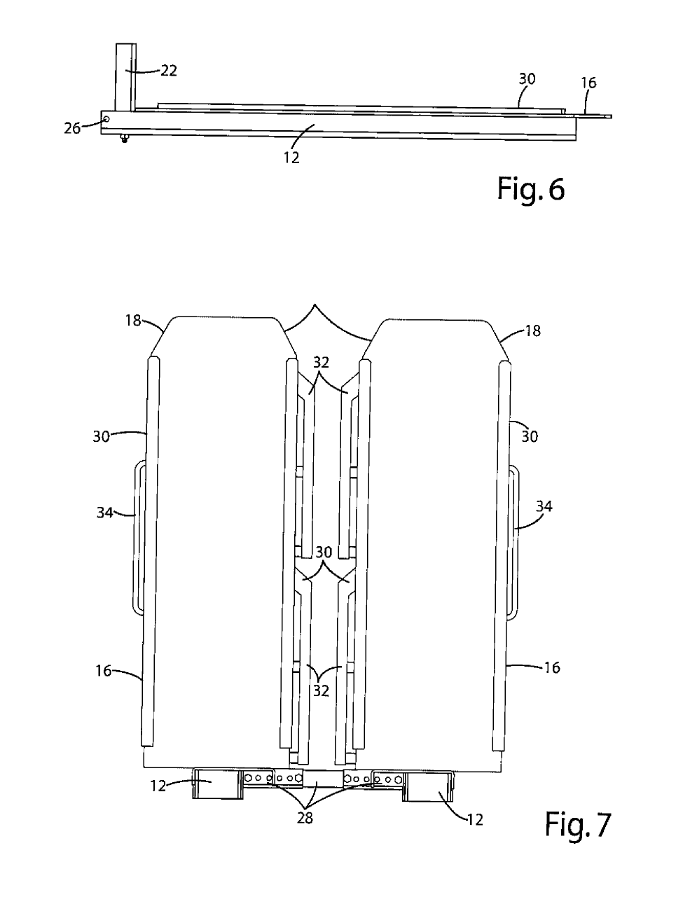

As shown in FIGS. 1, 2, 6 and 7, to further facilitate the stable transport of the pallet 20, the lateral edges of the load-carrying surface 16 may be raised edges 30 to provide a greater surface area which is in contact with the underside of a particular pallet 20 or to interlock with the features of the underside of the body of the pallet 20. The raised edges 30 may extend the entire length of load-carrying surface 16 (FIG. 1), or some segment thereof which is sufficient to engage with the pallet 20 (FIG. 2). For example, the pallet 20 described in U.S. application Ser. No. 12/578,834, filed Oct. 14, 2009, includes features on the underside of the pallet's 20 body which extend downward to securely interlock with the features of a particular hand cart and limit lateral movement of the pallet 20. These features may make the pallet 20 less stable on the tine attachment 10, if they are to provide the only supporting engagement with the load-carrying surface 16 of the tine attachment 10. To provide a more stable base under the pallet 20, and to similarly limit lateral movement of the pallet 20, raised edges 30, which are preferably at least as tall as the height of the downwardly extending features on pallet 20, may be provided on the lateral edges of the load-carrying surface 16 as shown herein. Additionally, the raised edges 30 of the load-carrying surface 16 may also be provided with knobs or notches or any other shape for engaging mating surfaces on pallet 20, to further facilitate a stable interface between the load-carrying surface 16 and the lower surface of the pallet 20.

In an alternate preferred embodiment, as disclosed in FIG. 7, to position a particular pallet 20, one or both of the load-carrying surfaces 16 may have an inboard pallet positioner 32 and one or both of the load-carrying surfaces 16 may have an outboard pallet positioner 34. The inboard pallet positioners 32 and the outboard pallet positioners 34 may consist of one or more rails extending horizontally from the load-carrying surface 16 or the side of the sleeve 12 which slides over the forklift tine 14. The inboard pallet positioners 32 and outboard pallet positioners 34 may be connected to the rest of the attachment 10 using one or more connection points and one or more reinforcing pieces, as desired to accommodate the intended pallet 20. The inboard pallet positioner 32 extends from the interior of one load-carrying surface 16 toward the other load-carrying surface 16 and the outboard pallet positioner 34, extends from the load-carrying surface 16 to the outside, away from the other load-carrying surface 16.

In one potential preferred embodiment, as shown in FIG. 7, the inboard pallet positioners 32 each comprise more than one piece, with each piece having a lead-in that angles back and away from the front edge of the load carrying surface 16 and then a body which is oriented substantially parallel with the edge of the load-carrying surface 16. The position, length, size and shape of the inboard pallet positioner 32, if used, may be based on the design of the pallet 20 to be loaded. The inboard pallet positioner 32 can be set at a predetermined width which will define the maximum gap between adjacent pallets 20 which are loaded on the tine attachment 10.

The outboard pallet positioner 34 may (but is not necessarily required to) have a shape which varies from that of the inboard pallet positioner 32. In the preferred embodiment illustrated in FIG. 7, the outboard pallet positioner 34 is semi-rectangular in shape, with rounded corners. As with the inboard pallet positioner 32, the desired position, length size and shape of the outboard pallet positioner 34 will be determined by the particular pallet 20 with which the attachment 10 is intended to be used. The outboard pallet positioner 34 can be set at a predetermined width which will define the minimum gap between adjacent pallets 20 which are loaded on the tine attachment 10. Generally, it may be desirable to keep at least a 0.5 inch minimum gap between adjacent pallets 20 to prevent their interference with each other. The outboard pallet positioner 34 may be fastened to a portion of the tine attachment 10 frame directly underneath the load carrying surface 16 or may be fastened to the tine attachment 10 frame near its lowest possible point to permit stabilization of pallets 20 with increased ground clearance as described herein by preventing or limiting the motion of the legs of the pallet 20.

The inboard pallet positioner 32 and outboard pallet positioner 34 are fixed in location at least while the attachment 10 is in use, and operate to force the pallets 20 into the proper position on the load-carrying surfaces 16.

By the foregoing description, it will be readily appreciated by those skilled in the art that modifications may be made to the invention without departing from the concepts disclosed herein. Such modifications are to be considered as included in the invention and the claims, unless the claims by their language expressly state otherwise.

1. A forklift tine attachment device, comprising:
A generally flat load carrying surface, extending laterally beyond the width of a forklift tine, wherein the load carrying surface further comprises raised guides to interact with the load to be carried on the load carrying surface so as to stabilize the position of the load on the load carrying surface; and
A channel, affixed to the underside of the load carrying surface, having sides and a bottom, wherein the channel is of a sufficient size and shape to slide over and removably attach the device to the forklift tine.

2. The forklift tine attachment device of claim 1, having a pair of channels.

3. The forklift tine attachment device of claim 2, having a pair arms, with each arm comprising a load carrying surface and a channel.

4. The forklift tine attachment device of claim 3, wherein each load carrying surface is complimentarily shaped to a predetermined pallet so that two pallets can be carried in side-to-side arrangement by the forklift tine attachment device.

5. The forklift tine attachment device of claim 4, further comprising an inboard pallet positioning rail affixed to and extending from one arm toward the space between the load carrying surfaces.

6. The forklift tine attachment device of claim 5, further comprising an outboard pallet positioning rail affixed to and extending from one arm in a direction away from the other arm.

7. The forklift tine attachment device of claim 4, further comprising an outboard pallet positioning rail affixed to and extending from one arm in a direction away from the other arm.

8. The forklift tine attachment device of claim 1, wherein the raised guides are present on the lateral edges of the load carrying surface.

9. The forklift tine attachment device of claim 4, wherein the raised guides are present on the lateral edge of each load carrying surface, and are complimentary to the shape of the underside of the pallets for use with the forklift tine attachment device.

10. The forklift tine attachment device of claim 3, further comprising complementary telescopically connectable pieces affixed to each arm, such that the arms are capable of being telescopically connected to each other at an adjustable width.

11. The forklift tine attachment device of claim 10, further comprising an inboard pallet positioning rail affixed to and extending from one arm toward the space between the load carrying surfaces.

12. The forklift tine attachment device of claim 11, wherein the inboard pallet positioning rail is angled away from the front edge of the arm, and extends rearwardly therefrom.

13. The forklift tine attachment device of claim 11, further comprising an outboard pallet positioning rail affixed to and extending from one arm in a direction away from the other arm.

14. The forklift tine attachment device of claim 10, further comprising an outboard pallet positioning rail affixed to and extending from one arm in a direction away from the other arm.

15. A method of using the forklift tine attachment device of claim 3, comprising the following steps:
Aligning a first arm of the forklift tine attachment device with a first pallet and moving the forklift tine attachment device forward to be positioned underneath the first pallet, and lifting the first pallet; and
Aligning a second arm of the forklift tine attachment device with a second pallet and moving the forklift tine attachment device forward to be positioned underneath the second pallet and lifting the second pallet.

16. The method of claim 15, wherein the first and second arms are simultaneously aligned with the first and second pallets.

17. The method of claim 16, wherein the forklift tine attachment device further comprises an inboard pallet positioning rail to aid in the alignment of the arms with the pallets.

18. The method of claim 17, wherein the forklift tine attachment device further comprises an outboard pallet positioning rail to aid in the alignment of the arms with the pallets.

19. The method of claim 15, wherein the forklift tine attachment device further comprises an outboard pallet positioning rail to aid in the alignment of the arms with the pallets.
